(19) United States
(12) Patent Application Publication
(10) Pub. No.: US 2026/0167472 A1
(43) Pub. Date: Jun. 18, 2026

(54) ELECTRIC OR HYBRID WORKING VEHICLE COMPRISING A LIFTING ARM

(71) Applicant: MANITOU BF, ANCENIS (FR)

(72) Inventors: Guillaume GABILLARD, ANCENIS (FR); Maurice BESSEAU, ANCENIS (FR)

(21) Appl. No.: 19/407,463

(22) Filed: Dec. 3, 2025

(30) Foreign Application Priority Data
Dec. 12, 2024 (FR) 2413986

(51) Int. Cl. B66F 9/075; B66F 9/065

(52) U.S. Cl. CPC B66F 9/07572; B66F 9/065; B66F 9/07568

(57) ABSTRACT

An electric or hybrid working vehicle comprises a chassis comprising two parallel longitudinal members, a lifting arm extending parallel to the longitudinal axis, the lifting arm being articulated on the two longitudinal members between the two longitudinal members so as to be pivotable about a pivot axis extending perpendicularly to the longitudinal axis. A pair of front wheels is mounted on a front end portion of the chassis and a pair of rear wheels is mounted on a rear end portion of the chassis. Each of the wheels is rotated by a drive device (21) independent of all the other wheels, is suspended on the chassis by a suspension device (31, 34, 40) independent of all the other wheels, and is orientable with respect to the chassis by an orientation device (48) independent of all the other wheels.

### TECHNICAL FIELD

The invention relates to an electric or hybrid working vehicle comprising a lifting arm.

### PRIOR ART

Document WO2023001621A1 discloses an electric or hybrid working vehicle comprising a mobile chassis movable over the surface of the ground, the chassis comprising two longitudinal members parallel to each other and extending parallel to a front-rear axis of the vehicle, and a lifting arm, the lifting arm being mounted between the two longitudinal members so as to be pivotable with respect to the two longitudinal members.

Such a working vehicle is equipped with two axles which have the advantage of taking on various functions, such as fixing of the wheels, connection of the wheels to the chassis, steering of the steered wheels, connection of the drive wheels to the electric transmission motor, and speed reduction.

However, for working vehicles intended for lifting, the power required to propel the chassis and to actuate the lifting arm is significant.

### SUMMARY OF THE INVENTION

Some aspects of the invention are based on the idea of improving the efficiency of the traction function in order to propose a machine that is as energy-saving as possible.

Some aspects of the invention are based on the idea of extending the life of the machine by facilitating the replacement or maintenance of the components with limited life.

According to a first object, the invention thus proposes an electric or hybrid working vehicle comprising:
a chassis comprising two longitudinal members parallel to each other and extending parallel to a longitudinal axis of the working vehicle;
a lifting arm extending parallel to the longitudinal axis, the lifting arm being articulated on the two longitudinal members between the two longitudinal members so as to be pivotable with respect to the two longitudinal members about a pivot axis extending perpendicularly to the longitudinal axis;
a pair of front wheels mounted on a front end portion of the chassis and a pair of rear wheels mounted on a rear end portion of the chassis,
wherein each of the wheels of at least one pair among the pair of front wheels and the pair of rear wheels is rotated by a drive device independent of all the other wheels, is suspended on the chassis by a suspension device independent of all the other wheels, and is orientable with respect to the chassis by an orientation device independent of all the other wheels.

According to one embodiment, each of the wheels among the pair of front wheels and among the pair of rear wheels is rotated by a wheel motor independent of all the other wheels, is suspended on the chassis by a suspension device independent of all the other wheels, and is orientable with respect to the chassis by an orientation device independent of all the other wheels.

A working vehicle is thus obtained in which each of the front wheels and/or the rear wheels is independent in terms of traction, steering and suspension, which allows a great deal of modularity and can offer varied functionalities in terms of driving the working vehicle.

In particular, the independent orientability of each wheel makes it possible to offer, in addition to the conventional modes of movement with 2 or 4 steered wheels, advanced movement functionalities, such as rectilinear crab movement, oblique rectilinear movement, rotation on the spot about a vertical axis, etc.

The end portion here designates not only an end of the chassis but also a region close to the end. Thus, the chassis may have an overhanging portion at the front of the front wheels and/or at the rear of the rear wheels.

According to embodiments, such a working vehicle may have one or more of the following features.

According to one embodiment, the drive device of a said wheel comprises an electric geared motor unit and a wheel carrier coupled directly to an output shaft of the electric geared motor unit, said wheel being mounted on the wheel carrier.

According to one embodiment, the orientation device of said wheel comprises a hub frame carrying the electric geared motor unit and a hub carrier on which the hub frame is pivotably mounted about a vertical orientation axis.

For driving a wheel, the vehicle can thus use an electric geared motor unit, in other words an electromechanical drive. The electric geared motor unit comprises a reduction gear train. The electric geared motor unit can be dedicated to propulsion.

According to one embodiment, the hub carrier comprises a connecting piece coupled to the chassis by the suspension device of said wheel and two pivot bearings spaced apart in the vertical direction and projecting outwardly from the connecting piece in a transverse direction of the chassis, the hub frame being pivotably mounted between the two pivot bearings.

According to one embodiment, the connecting piece has a curved profile with a concavity facing towards the hub frame.

According to one embodiment, the hub frame comprises a main support extending in the vertical direction, the main support being traversed by the electric geared motor unit in the transverse direction of the chassis, and two mounting lugs spaced apart in the vertical direction and projecting inwardly from the main support in the transverse direction of the chassis, the mounting lugs of the hub frame being pivotably mounted on the two pivot bearings.

Thanks to these features, it is possible to space the main support belonging to the hub frame and the connecting piece belonging to the hub carrier in the transverse direction of the chassis, which leaves a space capable of housing all or part of the electric geared motor unit. This results in a relatively compact arrangement.

According to one embodiment, the orientation device of said wheel further comprises a steering arm secured to at least one mounting lug of the hub frame and a steering actuator coupled to the steering arm to change an orientation of the hub frame about the vertical orientation axis.

According to one embodiment, the suspension device of said wheel comprises a lower arm extending in the transverse direction of the chassis and having an inner end articulated on the chassis and an outer end articulated on a lower portion of the connecting piece, the suspension device comprising a suspension cylinder extending in a vertical or oblique direction and having a lower end connected to the lower arm and an upper end connected to the chassis.

According to one embodiment, the suspension device of said wheel further comprises an upper arm extending in the transverse direction of the chassis and having an inner end articulated on the chassis and an outer end articulated on an upper portion of the connecting piece, the upper arm having an opening traversed by the suspension cylinder.

According to one embodiment, the chassis further comprises two transverse plates extending parallel to each other between the two longitudinal members at the front or rear end portion of the chassis, namely at the front end portion of the chassis for mounting the front wheels or at the rear end portion of the chassis for mounting the rear wheels. According to one embodiment, the inner end of the lower arm, and where appropriate the inner end of the upper arm, is housed between the two transverse plates and pivotably mounted about a longitudinal pivot axis carried or formed by the two transverse plates.

According to one embodiment, the inner ends of the lower arms of the suspension devices of the two wheels of said at least one pair are pivotably mounted about a first common longitudinal pivot axis carried or formed by the two transverse plates.

According to one embodiment, the inner ends of the upper arms of the suspension devices of the two wheels of said at least one pair are pivotably mounted about a second common longitudinal pivot axis carried or formed by the two transverse plates.

According to one embodiment, the first and/or second common longitudinal pivot axis are/is arranged at a central position between the two longitudinal members.

According to one embodiment, the chassis further comprises two intermediate plates arranged between the two transverse plates, the two intermediate plates extending parallel to the transverse plates between the two longitudinal members, the upper end of the suspension cylinder being housed between the two intermediate plates and pivotably mounted about a third longitudinal pivot axis carried or formed by the two intermediate plates.

According to one embodiment, the first and/or the second common longitudinal pivot axis traverse/traverses the two intermediate plates. In this case, the two intermediate plates make it possible to reinforce the mounting of the suspension arm axes.

According to one embodiment, the steering actuator is connected to the chassis by a fastening lug fastened to a said intermediate plate.

According to one embodiment, the chassis further comprises a horizontal bottom plate extending transversely between the two longitudinal members to form the bottom of a housing intended to accommodate the lifting arm in a lower position, and wherein the transverse plates extend vertically lower than the horizontal bottom plate.

Thanks to these features, it is possible to position the pivot axis or axes of the suspension arms lower than the horizontal bottom plate and thus to leave a space in the chassis below the bottom plate, for example to house electric batteries.

Alternatively, for driving a wheel, the vehicle may use one or more hydraulic motors instead of the electric geared motor unit, in other words an electrohydraulic drive. The hydraulic drivetrain may comprise a hydraulic pump driven by an electric pump motor and at least one hydraulic wheel motor driven by a hydraulic flow generated by the hydraulic pump. The hydraulic drivetrain may be a hydrostatic drivetrain, namely in a closed circuit. The hydraulic pump and electric motor can be dedicated to propulsion. Alternatively, the hydraulic pump and the electric pump motor can be common with other hydraulic functions of the vehicle, such as a hydraulic actuating function of the lifting arm or the like.

For the actuation of the lifting arm, the vehicle may comprise one or more electric actuators, namely an electric actuation for example by an electric cylinder, and/or one or more hydraulic actuators supplied by one or more pumps driven by one or more electric motors, namely an electrohydraulic actuation, for example by a hydraulic cylinder. A plurality of actuators of different kinds, for example at least one electric actuator and at least one hydraulic actuator, or of identical kinds, for example a plurality of hydraulic actuators, may be provided to actuate different movements or degrees of freedom of the lifting arm. For example, the different movements may be chosen from the group consisting of: a rising-descent movement, an extension-retraction movement and a tilting movement of a tool holder.

According to one embodiment, the working vehicle further comprises a hydraulic pump coupled to an electric pump motor and at least one hydraulic actuator supplied by the hydraulic pump to actuate at least one movement of the lifting arm.

In the case of an electrohydraulic actuation of one or more movements of the lifting arm and of an electrohydraulic drive of one or more pairs of wheels, independent hydraulic pumps may be used or a common hydraulic pump may be used. The independent hydraulic pumps may be driven by a plurality of respective electric motors.

In all cases, battery elements may be electrically connected to a single electric motor or to a plurality of electric motors to provide power to said electric motor(s) for propulsion of the chassis and for the actuation of the lifting arm.

According to one embodiment, the working vehicle further comprises a cab for a driver of the working vehicle, the cab being located projecting on a lateral side of the chassis of the working vehicle.

The weight of the cab can be balanced in different ways. For example, the weight of the cab can be balanced by elements located in a compartment projecting on a second lateral side of the chassis of the working vehicle, opposite the cab. These elements may include batteries, an electric propulsion motor, an electric actuating motor, a hydraulic pump, a hydraulic fluid reservoir and/or other elements.

### BRIEF DESCRIPTION OF THE FIGURES

The invention will be better understood, and further aims, details, features and advantages thereof will become more clearly apparent, in the course of the following description of several particular embodiments of the invention, which are given solely by way of non-limiting illustration, with reference to the appended drawings.

FIG. 1 is a perspective view of a working vehicle.

FIG. 2 is a perspective view of a chassis and of a ground connection system of the working vehicle of FIG. 1.

FIG. 3 is an enlarged view of the detail III of FIG. 2.

FIG. 4 is a sectional view of the chassis along the line IV-IV of FIG. 2.

### DESCRIPTION OF THE EMBODIMENTS

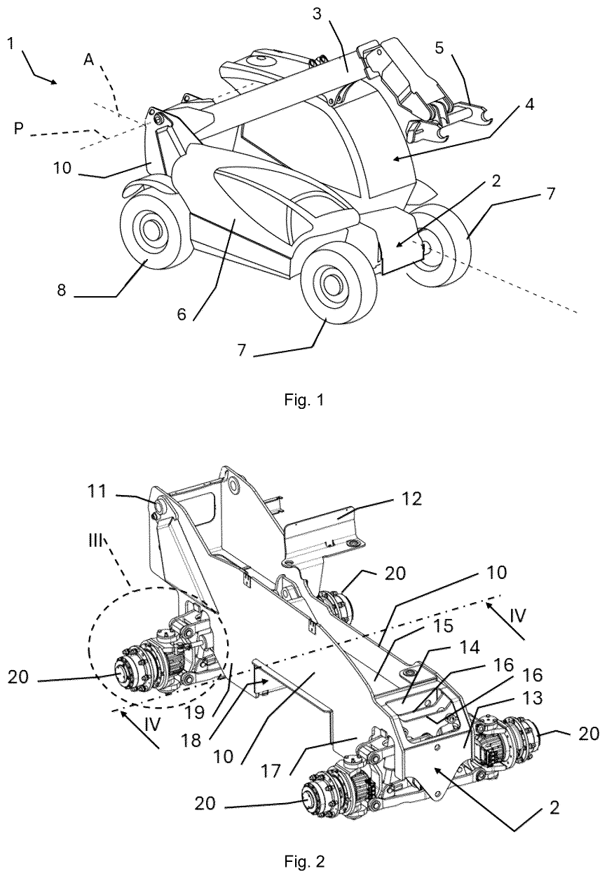

FIG. 1 is an overall perspective view of a working vehicle 1, embodied here in the form of a telescopic-arm lift truck. As shown in this figure, the working vehicle 1 comprises a chassis 2 and a lifting arm 3. Line A represents a longitudinal axis of the working vehicle 1.

The chassis 2 is mobile and can be moved over the surface of the ground (not shown) by means of two front wheels 7, one on the left and the other on the right, and two rear wheels 8, one on the left and the other on the right.

The chassis 2 comprises two longitudinal members 10, which are better visible in particular in FIG. 2. The longitudinal members 10 are generally flat metal parts, parallel to each other and generally perpendicular to a width direction of the working vehicle. The largest dimension of the longitudinal members 10 extends parallel to the longitudinal axis of the working vehicle 1. The frame 2 is typically a mechanically welded assembly that can be made of steel sheets.

The lifting arm 3 also extends in the longitudinal direction of the working vehicle 1. The lifting arm 3 is arranged between the two longitudinal members 10 and has a proximal end articulated on the two longitudinal members 10 at two bearings 11 so as to be pivotable with respect to the two longitudinal members 10 about a pivot axis P. The pivot axis P is parallel to the width direction of the working vehicle 1. The means suitable for making the lifting arm 3 pivotable are well known per se and are not described in detail here.

The lifting arm 3 can be embodied in various ways, in particular in the form of a plurality of telescopic sections as shown, or in a variant in the form of an arm of fixed length. A distal end of the lifting arm 3 opposite the pivot axis P may carry a working tool or, as shown in FIG. 1, a modular tool holder 5 capable of receiving working tools of a plurality of types, according to the known technique. What is meant by a working tool is, for example, a pair of forks, a bucket, a winch, a gripper, etc.

It can also be seen in FIG. 1 that the working vehicle 1 comprises a cab 4 in which a driver of the working vehicle 1 can sit, and a box 6 able to receive various pieces of equipment used for the operation of the working vehicle 1. The cab 4 and the box 6 are located here on either side of the longitudinal members 10, that is to say that the cab 4 is located on a first lateral side of the working vehicle 1, and that the box 6 is located on a second lateral side of the working vehicle, the first lateral side and the second lateral side being on either side of the two longitudinal members 10.

The cab 4 can be mounted by means of a support arm 12 which projects laterally from a longitudinal member 10, as can be seen in FIG. 2.

A set of batteries (not shown) is connected to electric motors of the working vehicle 1, which will be described in detail below. The set of batteries can be of different types, for example of the lead-acid or lithium-ion type. The working vehicle 1 may comprise a power distribution circuit (not shown), including, for example, electric speed variators, which is configured to power the electrical components of the working vehicle 1. Such power distribution circuits are known per se and are not described in detail here.

The set of batteries and/or the power distribution circuit may, for example, be received in the box 6.

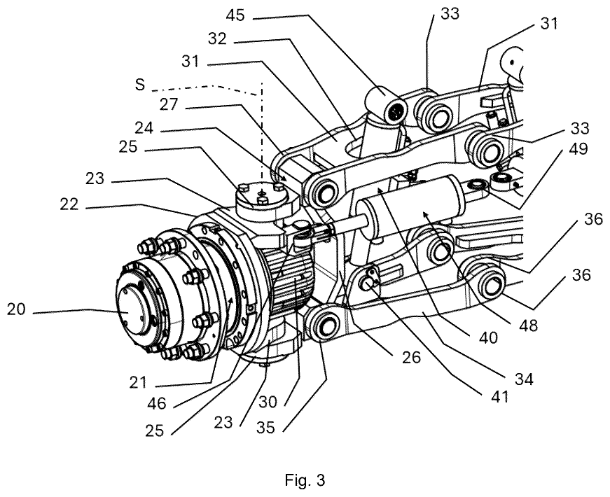

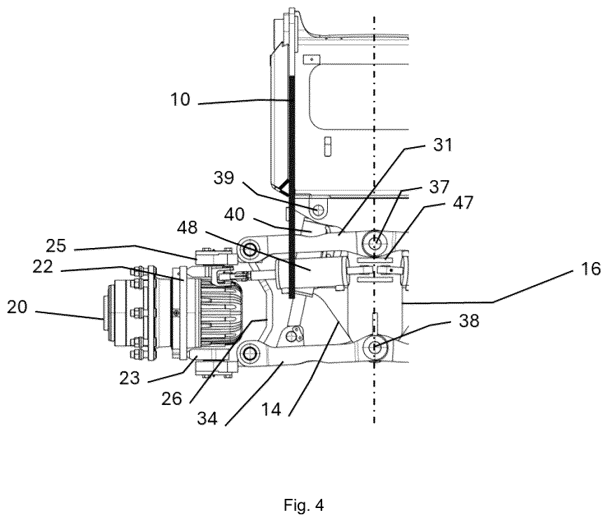

The ground connection system of the working vehicle 1 is generally visible in FIG. 2. FIG. 2 shows the wheel carriers 20 intended to receive the four wheels 7 and 8. The connection device which connects the wheel carrier 20 to the chassis 2 can be embodied identically for the four wheels and will now be described with reference to FIGS. 3 and 4.

The wheel carrier 20 is mounted on the output shaft of a geared motor unit 21 which comprises an electric motor and a reduction gear train housed in a common casing 30. Such a geared motor unit is commercially available. In FIGS. 1 to 4, the axis of wheels 7 and 8 and of the wheel carriers 20 is systematically shown oriented in the transverse direction of the chassis perpendicular to the longitudinal axis A, which is a configuration corresponding to a straight-line movement. It goes without saying that the orientability of the wheels makes it possible to change this orientation, as will be described below. However, for the sake of conciseness, the structure of the ground connection will be described below in this straight-line configuration and assuming that the vehicle is resting on horizontal ground.

The casing of the geared motor unit 21 is mounted rigidly on a hub frame which provides the connection between the geared motor unit 21 and a hub carrier 24. The hub frame consists of a main support plate 22, the contour of which (visible in FIG. 3) has a generally circular shape, and two mounting lugs 23 which project from the main support plate 22 transversely towards the chassis 2.

The main support plate 22 has a central opening (not shown) which is traversed by the geared motor unit 21. Thus, a first portion of the geared motor unit 21 is located on the inner side of the main support plate 22 in the transverse direction, and a second portion of the geared motor unit 21, smaller than the first portion, is located on the outer side of the main support plate 22.

The two mounting lugs 23 are housed between two flanges 25 of the hub carrier 24 forming pivot bearings to allow pivoting of the geared motor unit 21 (and therefore of the corresponding wheel) about a vertical axis S. In order to control this pivoting, and therefore the orientation of the corresponding wheel, there is a steering actuator, here in the form of a steering cylinder 48 having an outer end coupled to a steering arm 46 secured to the upper mounting lug 23, and an inner end 49 coupled to the chassis 2 by means of a fastening lug 47 (FIG. 4).

The hub carrier 24 comprises the two flanges 25 spaced apart in the vertical direction and a connecting plate 26 which extends generally in the vertical direction and carries the two flanges 25 at its upper and lower ends. The two flanges 25 project from the connecting plate 26 transversely away from the chassis 2. The first portion of the geared motor unit 21 is therefore arranged in a space formed between the connecting plate 26 and the main support plate 22. In addition, the connecting plate 26 has a curvature whose concavity faces towards this space in order to increase the dimension thereof. This arrangement makes it possible to house a first relatively large portion of the geared motor unit 21, which limits the transverse bulk of the ground connection system.

Having described the drive device and the orientation device of a wheel, the suspension device thereof will now be described. The latter consists mainly of an upper suspension arm 31, a lower suspension arm 34 and a suspension cylinder 40.

The upper and lower ends of the connecting plate 26 each carry a bearing enabling the outer end 27 of the upper suspension arm 31 and the outer end 35 of the lower suspension arm 34 to be assembled thereto, respectively, with a degree of freedom in pivoting about two horizontal and longitudinal axes.

Similarly, the inner end 33 of the upper suspension arm 31 and the inner end 36 of the lower suspension arm 34 are assembled to the chassis 2 with a degree of freedom in pivoting about two horizontal and longitudinal axes.

Each of the upper 31 and lower 34 suspension arms is generally H-shaped. In the lower suspension arm 34, the transverse bar of the H supports the lower end of the suspension cylinder 40, which is assembled to it with a degree of freedom in pivoting about a horizontal and longitudinal axis 41. The suspension cylinder 40 extends obliquely from its lower end to an upper end 45 which is assembled to the chassis 2 with a degree of freedom in pivoting about a horizontal and longitudinal axis 39 (FIG. 4). At the upper suspension arm 31, the suspension cylinder 40 passes through an opening 32 between the two branches of the H.

As can be seen in FIGS. 3 and 4, the upper suspension arms 31 of two transversely opposite wheels are connected to the chassis by means of a common pivot axis 37 and the lower suspension arms 34 of two transversely opposite wheels are connected to the chassis by means of a common pivot axis 38. The common pivot axes 37 and 38 are spaced apart in the vertical direction and located in a central position with respect to the chassis 2, namely halfway between the two longitudinal members 10.

Returning to FIG. 2, in the front end portion of the chassis 2, it can be seen that the mounting of the pivot axes of the suspension arms involves two parallel transverse plates 13 and 14 which extend perpendicularly to the longitudinal axis A and join the two longitudinal members 10. The transverse plate 13 here forms the front end of the chassis 2, while the transverse plate 14 is spaced from the latter towards the rear. The same arrangement, shown partially in FIG. 4, can be used in the rear end portion of the chassis 2. Between the two transverse plates 13 and 14 there are two intermediate plates 16, also parallel, which also extend perpendicularly to the longitudinal axis A and join the two longitudinal members 10.

The common pivot axes 37 and 38 of the suspension arms can extend longitudinally from the transverse plate 13 to the transverse plate 14 by passing through the two intermediate plates 16, which offers particularly robust mounting. The upper 31 and lower 34 suspension arms are arranged each time in such a way that the two branches of the H are arranged respectively on either side of the two intermediate plates 16, namely between the transverse plate 13 or 14 and one of the intermediate plates 16.

As for the suspension cylinders 40, their upper ends 45 are housed between the intermediate plates 16 and their pivot axes 39 extend longitudinally between the two intermediate plates 16, which offers robust mounting.

In operation, the upper 31 and lower 34 suspension arms of a wheel can oscillate parallel to each other forming a parallelogram articulated with the connecting plate 26 and the intermediate plates 16. Their oscillation is damped by the suspension cylinder 40.

As can be seen in FIG. 4, the fastening lug 47 can be fastened to the intermediate plate 16 located further to the front.

As can be seen in FIG. 2, the centre of the chassis 2 comprises a horizontal plate 15 which joins the two longitudinal members 10 and forms a bottom wall for a housing intended to accommodate the lifting arm 3 in a lower folded position. With respect to the horizontal plate 15, the front end portion 17 of the longitudinal members 10 extends lower in the vertical direction. This allows the transverse plates 13 and 14 and the intermediate plates 16 which are fastened, in particular welded, to the front end portion 17 of the longitudinal members 10 to also extend lower than the horizontal plate 15 in the vertical direction. The same applies at the rear end portion 19 of the longitudinal members 10. This arrangement makes it possible to free a central space 18 in the lower part of the chassis, namely below the horizontal plate 15 between the rear end portion 19 and the front end portion 17 of the longitudinal members 10, while maintaining satisfactory ground clearance for all-terrain use. This central space 18 can receive various components, for example electric batteries.

In a variant embodiment, only one of the two pairs of wheels conforms to the ground connection system which has just been described. The other pair of wheels can be mounted differently.

In the examples described above, the front wheels 7 and/or the rear wheels 8 are driven by electric propulsion motors. However, other configurations are possible, and in particular a hydraulic drivetrain. Thus, in all the preceding examples, a or each electric motor may be replaced by a hydraulic motor fulfilling the same function as the electric motor.

In a variant embodiment, a combustion engine may be provided in addition to the electric motors, in particular to generate electricity by means of an on-board generator and/or to provide additional drive torque to an electric pump motor.

Although the invention has been described in connection with several particular embodiments, it is quite evident that it is in no way limited thereto and that it comprises all the technical equivalents of the means described and the combinations thereof where these fall within the scope of the invention.

The use of the verb “have”, “comprise” or “include” and its conjugated forms does not exclude the presence of elements or steps other than those set out in a claim.

In the claims, any reference sign between parentheses should not be interpreted as a limitation of the claim.

What is claimed is:

1. A working vehicle, comprising:
a chassis including two longitudinal members parallel to each other and extending parallel to a longitudinal axis of the working vehicle;
a lifting arm extending parallel to the longitudinal axis, the lifting arm being articulated on the two longitudinal members and between the two longitudinal members so as to be pivotable with respect to the two longitudinal members about a pivot axis extending perpendicularly to the longitudinal axis;
a pair of front wheels mounted on a front end portion of the longitudinal members of the chassis and a pair of rear wheels mounted on a rear end portion of the longitudinal members of the chassis;
wherein each wheel of at least one pair among the pair of front wheels and the pair of rear wheels is rotated by a drive device independent of all the other wheels, is suspended on the chassis by a suspension device independent of all the other wheels, and is orientable with respect to the chassis by an orientation device independent of all the other wheels.

2. The working vehicle of claim 1, wherein each wheel among the pair of front wheels and among the pair of rear wheels is rotated by a wheel motor independent of all the other wheels, is suspended on the chassis by a suspension device independent of all the other wheels, and is orientable with respect to the chassis by an orientation device independent of all the other wheels.

3. The working vehicle of claim 1, wherein each drive device includes an electric geared motor unit and a wheel carrier coupled directly to an output shaft of the electric geared motor unit, the wheel respectively rotated by the drive device being mounted on the wheel carrier.

4. The working vehicle of claim 3, wherein each orientation device includes a hub frame carrying the electric geared motor unit and a hub carrier on which the hub frame is pivotably mounted about a vertical orientation axis.

5. The working vehicle of claim 4, wherein the hub carrier includes
a connecting piece coupled to the chassis by the suspension device and
two pivot bearings spaced apart in the vertical direction and projecting outwardly from the connecting piece in a transverse direction of the chassis, the hub frame being pivotably mounted between the two pivot bearings.

6. The working vehicle of claim 5, wherein the connecting piece has a curved profile with a concavity facing towards the hub frame.

7. The working vehicle of claim 5, wherein the hub frame includes a main support extending in the vertical direction, the main support being traversed by the electric geared motor unit in the transverse direction of the chassis, and two mounting lugs spaced apart in the vertical direction and projecting inwardly from the main support in the transverse direction of the chassis, the mounting lugs of the hub frame being pivotably mounted on the two pivot bearings.

8. The working vehicle of claim 7, wherein each orientation device includes a steering arm secured to at least one mounting lug of the hub frame and a steering actuator coupled to the steering arm for changing an orientation of the hub frame about the vertical orientation axis.

9. The working vehicle of claim 5, wherein each suspension device of includes a lower arm extending in the transverse direction of the chassis and having an inner end articulated on the chassis and an outer end articulated on a lower portion of the connecting piece, and
each suspension device includes a suspension cylinder extending in a vertical or oblique direction and having a lower end connected to the lower arm and an upper end connected to the chassis.

10. The working vehicle of claim 9, wherein each suspension device includes an upper arm extending in the transverse direction of the chassis and having an inner end articulated on the chassis and an outer end articulated on an upper portion of the connecting piece, the upper arm having an opening traversed by the suspension cylinder.

11. The working vehicle of claim 9, wherein the chassis further includes two transverse plates extending parallel to each other between the two longitudinal members at the front or rear end portion of the chassis, and wherein the inner end of the lower arm is housed between the two transverse plates and pivotably mounted about a first common longitudinal pivot axis carried or formed by the two transverse plates.

12. The working vehicle of claim 11, wherein the inner ends of the lower arms of the suspension devices of the two wheels of the at least one pair are pivotably mounted about the first a common longitudinal pivot axis carried or formed by the two transverse plates.

13. The working vehicle of claim 11,
wherein each suspension device includes an upper arm extending in the transverse direction of the chassis and having an inner end articulated on the chassis, and
wherein the inner end of the upper arms of the suspension devices of the two wheels of the at least one pair are pivotably mounted about a second common longitudinal pivot axis carried or formed by the two transverse plates.

14. The working vehicle of claim 13, wherein one or more of the first common longitudinal pivot axis and the second common longitudinal pivot axis are arranged at a central position between the two longitudinal members.

15. The working vehicle of claim 11, wherein the chassis further includes two intermediate plates arranged between the two transverse plates the two intermediate plates extending parallel to the transverse plates between the two longitudinal members, the upper end of the suspension cylinder being housed between the two intermediate plates and pivotably mounted about a third common longitudinal pivot axis carried or formed by the two intermediate plates.

16. The working vehicle of claim 15,
wherein each orientation device includes a steering arm secured to at least one mounting lug of the hub frame and a steering actuator coupled to the steering arm for changing an orientation of the hub frame about the vertical orientation axis,
wherein the steering actuator is connected to the chassis by a fastening lug fastened to one of the intermediate plates.

17. The working vehicle of claim 11, wherein the chassis further includes a horizontal bottom plate extending transversely between the two longitudinal members to form the bottom of a housing intended for accommodating the lifting arm in a lower position, and wherein the transverse plates extend vertically lower than the horizontal bottom plate.

18. A working vehicle, comprising:
a chassis defining a longitudinal axis;
a plurality of wheels mounted to the chassis;
wherein each wheel of the plurality of wheels is rotated by a drive device independent of one another, suspended on the chassis by a suspension device independent of one another, and
orientable with respect to the chassis by an orientation device independent one another.

19. The working vehicle of claim 17, wherein each wheel of the plurality of wheels is rotated by a wheel motor independent of one another.

20. The working vehicle of claim 1, wherein
each drive device includes an electric geared motor unit and a wheel carrier coupled directly to an output shaft of the electric geared motor unit, and
the wheel respectively rotated by the drive device is mounted on the wheel carrier.
